(19) United States
(12) Patent Application Publication
(10) Pub. No.: US 2015/0104555 A1
(43) Pub. Date: Apr. 16, 2015

(54) SPLATTER SHIELD FOR COOKING

(71) Applicant: Jaz Innovations, LLC, Toledo, OH (US)

(72) Inventor: James J. Huttner, Sylvania, OH (US)

(73) Assignee: Jaz Innovations, LLC, Toledo, OH (US)

(21) Appl. No.: 14/509,228

(22) Filed: Oct. 8, 2014

Related U.S. Application Data
(60) Provisional application No. 61/889,567, filed on Oct. 11, 2013.

(51) Int. Cl. A47J 37/10; A23L 1/01

(52) U.S. Cl. CPC A47J 37/101; A23L 1/0107; A23V 2002/00
USPC 426/438; 126/383.1; 220/369

(57) ABSTRACT

A splatter shield is provided for controlling grease splatter from food being cooked within a cooking vessel. The splatter shield includes a generally annular sidewall that slopes upwardly and radially inwardly from a lower rim to an upper rim. The upper rim of the splatter shield defines an upper opening in the splatter shield that is sufficiently large to permit the introduction of a cooking utensil therethrough, and the lower rim defines a lower opening in the splash shield. The upper opening in the splatter shield is smaller than the lower opening.

### CROSS-REFERENCE TO RELATED APPLICATION

This application is claiming the benefit, under 35 U.S.C. §119(e), of the provisional application filed Oct. 11, 2013 under 35 U.S.C. §111(b), which was granted Ser. No. 61/889,567. The noted provisional application is hereby incorporated by reference in its entirety.

### BACKGROUND OF THE INVENTION

Frying foods on the stove-top invariably results in the splattering of grease on the surrounding cooking surface and countertop as the food cooks. This results from the interaction of hot grease with water and water-based components of the food being fried. Splattering grease can be a significant health hazard as well as a nuisance; the hot grease can cause serious burns to skin, can stain clothing, and can necessitate lengthy clean-up procedures.

Splatter shields (also known and referenced as splatter screens, spatter screens, and spatter guards) have been developed and used for years to address this problem. In their most common form, splatter shields are round or rectangular screens held in a wire frame of a size large enough to span the diameter of a frying pan. The screens are usually fine, stainless steel mesh that traps most of the oil droplets as they fly from the pan during cooking. The mesh screens also importantly allow steam to escape during the cooking process; this prevents the food from steaming instead of frying, which would result in an unpalatable result. During use, the splatter shield is rested atop the frying pan so that the screen is in contact with the rim of the pan. A handle is usually incorporated into the splatter shield, as it is necessary to lift or remove the splatter shield during the cooking process in order to stir or turn the food being cooked. It is important to note that a significant amount of grease splatter (with its attendant hazards) is released during the time that the splatter shield is lifted or removed.

Other forms of splatter shields exist. One form comprises the metal mesh screen as described above but formed into a dome-like form. A domed splatter screen allows bulkier foods to be cooked, but otherwise functions similar to flat mesh screens as described above. Again, a handle allows the domed splatter screen to be lifted or removed during the cooking process to stir or turn the food.

Another version of a splatter shield uses a flat, solid metal round with holes or slits formed into it to allow steam to escape. Yet another version uses a heat resistant silicone sheet with holes or slits to allow steam to escape. Except for the material used in their construction, these versions of splatter shields are used and function similar to the flat metal mesh splatter shield as described above. Experience has shown that these versions of splatter shields in general retain more steam than do splatter shields made from metal mesh, and thus do not result in as palatable a result as the metal mesh shields.

A problem common to all the splatter shields described above is the need to lift or remove the splatter shield to stir or turn the food being cooked. Some domed splatter shields have incorporated a small opening at the base of the side of the shield to allow for a spoon to be inserted for stirring the food. The limited access provided by this small opening is too small and at too low an angle to allow the cook to adequately turn or manipulate larger pieces of foods such as chicken or bacon; merely enlarging the opening would allow significant grease splatter to escape out the side of the splatter shield.

A different style of splatter shield has been described by Joseph (U.S. Pat. No. 5,542,347). Joseph shows a splatter shield constructed of multiple segments having vertical walls. When linked together, these multiple segments form an effective cylinder resting inside the frying pan. Grease splatters thus impact the walls of the device. Joseph's device has several drawbacks making it an impractical device for cooking. First, there is the need to construct the grease trapping cylinder by linking multiple individual segments together while they are resting in a frying pan or cook pot that is presumed filled with hot oil over a flame. Second, the device shown by Joseph has high, vertical walls as these are necessary to contain the grease splatters. Although it is possible to reach the food during the cooking process, these high vertical walls necessitate reaching almost vertically into the frying pan with an entire arm (for smaller folks), risking being burned by splattering grease. Lastly, to remove the food after cooking, it is necessary to disconnect the individual segments at a point when they can be presumed to be greasy and extremely hot, making this a very hazardous endeavor.

Another different style of splatter shield was described by Boyer (U.S. Pat. No. 2,999,559). Boyer describes a splatter shield that is similar to a cook pot lid with a large opening in its center. Boyer does show that there is a short up-raised portion from this center opening. However, its purpose is to hold a grease absorbing cover—e.g. a material such as cloth or gauze—and NOT to deter grease splatter. It is evident from Boyer's design that if the grease absorbing cover were omitted during use, the close proximity of the opening and its overall low height would easily allow hot grease splatters to escape.

Yet another style of splatter shield has been constructed and manufactured by the Hutzler Manufacturing Company, Canaan, Conn. The Hutzler splatter shield is a conical shaped aluminum mesh device with a small hole in its top. Company literature states that the hole is there to allow cooking food to be stirred. No mention is made of any other manipulation of the cooking food, and the hole is far too small to allow insertion of other utensils such as tongs or spatulas. Also, the hole is located at the apex of the cone at a significant distance from cooking food, making it virtually impossible to perform such actions as turning or flipping frying foods due to the angle and distance involved. The question of why the Hutzler Company has not sought to manufacture a splatter shield similar to that proposed by this disclosure is relevant. Given their understanding of the art and long standing presence in the industry, it must be concluded that the current invention represents a novel and inventive solution to a problem that has not previously been addressed. The Hutzler Company splatter screen also has a handle.

### SUMMARY OF THE INVENTION

The invention seeks to remedy the deficiencies found in earlier splatter shield designs by providing a splatter shield with a half-domed or truncated cone configuration and having an substantially sized, central opening in its top. The walls of this splatter shield are configured to contain substantially all the grease splatter except that which goes vertically from the pan. The opening is wide enough to allow the cook easy access to the cooking food in order to turn, stir, or otherwise manipulate the food. Also, the opening allows substantially all the steam to escape, preventing steaming of the food instead of frying.

The splatter shield of the invention may be constructed of any heat-resistant material suitable for food contact, the most likely examples of which are stainless steel mesh and silicone. If stainless steel mesh is used, it is anticipated that it will be a fine mesh that will trap grease splatters but allow the passage of air and steam.

The splatter shield of the current invention is sized such that it rests securely on the rim of a standard frying pan or similar cookware. It is anticipated that multiple sizes may need to be offered to accommodate the range of available cookware sizes. Alternatively, a bracket may be attached to the bottom edge of the metal splatter shield to allow it to rest on the rims of frying pans of multiple sizes. Alternatively, a silicone version of the splatter shield may have a wide, flat bottom rim to allow it to rest securely on the rim of frying pans of multiple sizes.

The sidewall of the splatter shield of the current invention is generally annular, having an inwardly sloping configuration and surrounding the interior circumference of the frying pan without interruption or opening. In this fashion the sidewall may form either a truncated cone or truncated half-dome depending on the slope or curvature of the sidewall, without detracting from the functionality of the device. The sidewall may be made of stainless steel mesh, silicone, or other heat resistant material as described above.

The inward sloping configuration of the splatter shield sidewall is important for two reasons:

(1) It allows for efficient trapping of grease splatters. Grease splatters can be expected to eject from frying food in all directions. However, gravity will alter the trajectory of those splatters into an arc, and the inwardly sloping shape of the splatter shield sidewall is the most efficient configuration for impacting those splatters. It is expected that only splatters that are nearly vertical in direction (i.e., those near the central opening) will have much of a chance for escape from the interior of the splatter shield, and it is likely that those grease droplets will either drop back inside the frying pan or land on the exterior of the splatter shield; in any case the spray of grease splatters to the stove top or counter top will be greatly reduced.
(2) It is important to be able to manipulate the food during the frying/cooking process to ensure even and thorough cooking. For example, chicken pieces being fried must be turned to prevent burning. The inwardly sloping shape of the splatter shield sidewall allows for efficient trapping of grease splatters while at the same time maintaining a low overall height for the device, allowing the cook easy access to the frying pan contents. In contrast, splatter shields such as those described by Joseph (U.S. Pat. No. 5,542,347) and having vertical sides need very high vertical sidewall to trap grease splatters to the same degree. Those high vertical sidewalls make reaching and manipulating food over very hot grease a dangerous and difficult prospect.

The splatter shield of the invention has a substantially large central opening formed by the upper end of the sidewall that do not close upon themselves, unlike other commercially available splatter shields that exist either as closed, flat screens or domes, or where they almost close to the point of leaving only a small hole for steam to escape.

In accordance with the invention, the central opening is sized large enough to allow the chef to easily manipulate the food being cooked. This is important because food must often be stirred or flipped during the frying/cooking process to ensure even and thorough cooking. For example, chicken pieces being fried must be turned to prevent burning. The central opening also allows steam to escape, ensuring that the food will fry and not steam, which would lead to an unpalatable product.

### BRIEF DESCRIPTION OF THE DRAWINGS

The advantages of the invention will become readily apparent to those skilled in the art from the following detailed description of a preferred embodiment when considered in the light of the accompanying drawings, in which:

FIG. 1 is a perspective view of an embodiment of the splatter shield of the invention;

FIG. 2 is a side view of the splatter shield of FIG. 1;

FIG. 3 is a top view of the splatter shield of FIG. 1;

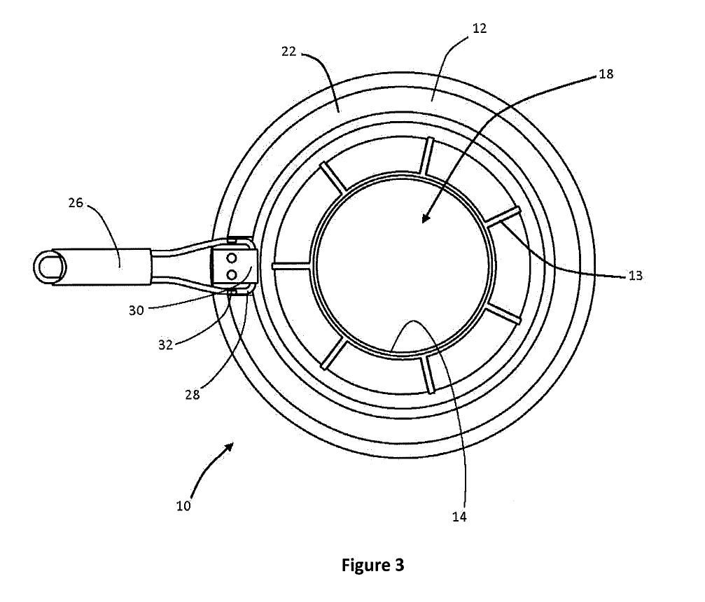

FIG. 4 is a side view of the splatter shield of FIG. 1 being positioned over a skillet in which food is being cooked;

FIG. 5 is a perspective view of a skillet in which food is being cooked the splatter shield of FIG. 1 shown in dotted lines;

FIG. 6 is a view as in FIG. 5 with a cooking utensil extending down through the central opening in the splatter shield;

FIG. 7 is a perspective view of another embodiment of the splatter shield of the invention being positioned over a skillet in which food is being cooked; and

FIG. 8 is a perspective view of a further embodiment of the splatter shield of the invention being positioned over a skillet in which food is being cooked.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

The splatter shield of the invention is formed with a half-domed or truncated cone configuration and includes a substantially sized, central opening in its top. The walls of this splatter shield are configured to contain substantially all the grease splatter except that which goes vertically from the pan. The opening is sufficiently large to allow the cook easy access to the cooking food in order to turn, stir, or otherwise manipulate the food within the cooking vessel without removing the splatter shield. The opening in the splatter shield also allows substantially all the steam to escape, preventing steaming of the food instead of frying.

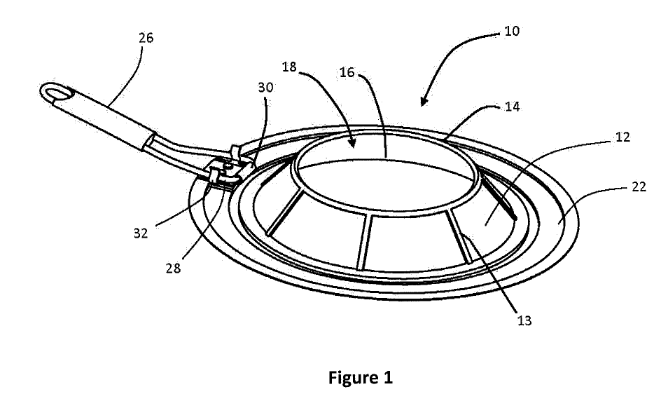

FIG. 1 shows a preferred embodiment of the splatter shield 10 of the invention. Clearly visible in FIG. 1 is the inwardly sloping configuration of the sidewall 12 of the splatter shield 10. In this embodiment of the splatter shield 10, the sidewall 12 is shown as having a substantially planar shape. It is understood that the sidewall configuration could also describe an inwardly sloping curved arc or other more convoluted shape without affecting the intent or performance of the splatter shield of the invention.

In a preferred embodiment, the sidewall 12 of the splatter shield 10 is comprised of heat resistant silicone rubber. It is well known to those skilled in the art that the silicone material may be either solid or perforated without affecting the performance of the material. Also, stiffening ribs 13 or other features may be added to give mechanical rigidity to the silicone portion without affecting the intended use or performance of the device. The illustrated stiffening ribs 13 are spaced apart about the circumference of the sidewall 12 and extend in a radial direction.

Preferably, the inwardly sloping sidewall 12 extend circumferentially around the periphery of the splatter shield 10, defining a truncated cone (in the case of a planar sidewall as illustrated in FIG. 1) or truncated dome (in the case of a curved arc sidewall). The sidewall 12 of the splatter shield 10 defines an upper edge or rim 14, a bottom edge or rim 16, and an interior portion having a substantially truncated conical (or dome-like) shape, respectively. It is an element of the invention that the central opening 18 defined by the upper edge 14 of the sidewall 12 of the splatter shield 10 has a diameter sufficiently large enough to admit the use of spatulas, tongs, spoons and other cooking utensils as needed to manipulate the food within a cooking vessel positioned beneath the splatter shield 10 during the cooking process.

The bottom edge 16 of the sidewall 12 defines an opening 20 having a diameter that is larger than the diameter of the opening 18 and that is generally similar to the diameter of the frying pan, pot or other cooking vessel upon which the splatter shield 10 rests. It is understood that frying pan and pot sizes are not standardized; any difference in diameters between the splatter shield 10 and the cooking vessel will be accommodated by the width of a support ring 22 that extends radially outward from the bottom edge 16 of the sidewall 12, as shown in FIG. 1.

In the embodiment shown in FIG. 1, the truncated cone formed by the inwardly sloping sidewall 12 is bonded to the support ring 22. The support ring 22 is a substantially broad, horizontal ring whose function is to enable the splatter shield device to rest atop frying pans, pots or cooking vessels of various sizes. In a preferred embodiment of the invention, this support ring 22 is comprised of metal, most preferably stainless steel. Stainless steel is most preferred because it is non-rusting and non-reactive to food, and is able to tolerate the high heat of frying foods; it is understood that other materials such as aluminum or heat resistant silicone may also be used.

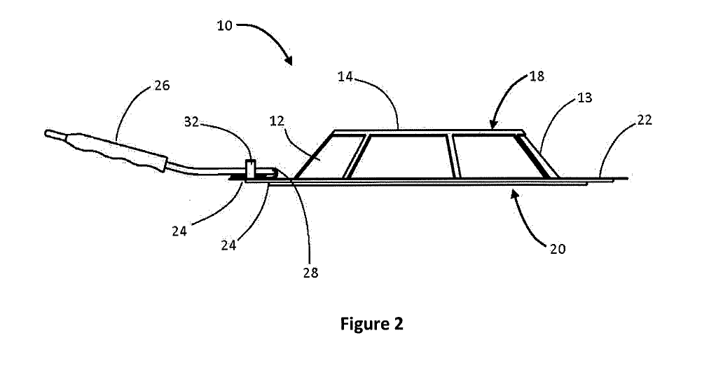

In order that the splatter shield 10 rests securely atop the cooking vessel, one or more “step” features 24 may be provided in the support ring 22, as best illustrated in FIG. 2. These “step” features 24 may be formed with downwardly projecting corners that are adapted to catch or seat against the inside rim of the cooking vessel in use. By including multiple “step” features 24 defining rings of different diameters, it is possible to enable the splatter shield 10 to rest securely atop cooking vessels of different diameter openings. The relatively broad width of the support ring 22 also allows the splatter shield to completely cover frying pans or cooking vessels of different interior diameters so that grease splatters are less likely to escape from the outside of splatter shield 10.

As further illustrated in FIG. 1, the splatter shield 10 also preferably includes a handle 26 to facilitate handling of the splatter shield 10 by a user. In a preferred embodiment, the handle 26 may be formed as a space-saving, folding handle as shown in FIG. 1. The handle 26 is able to pivot about its proximal end 28 in a sleeve 30 on the support ring 22, and is retained in its extended position (shown in FIGS. 1 and 2) by flexible clips 32 provided on the support ring 22. It is understood, of course, that a fixed handle will also suffice.

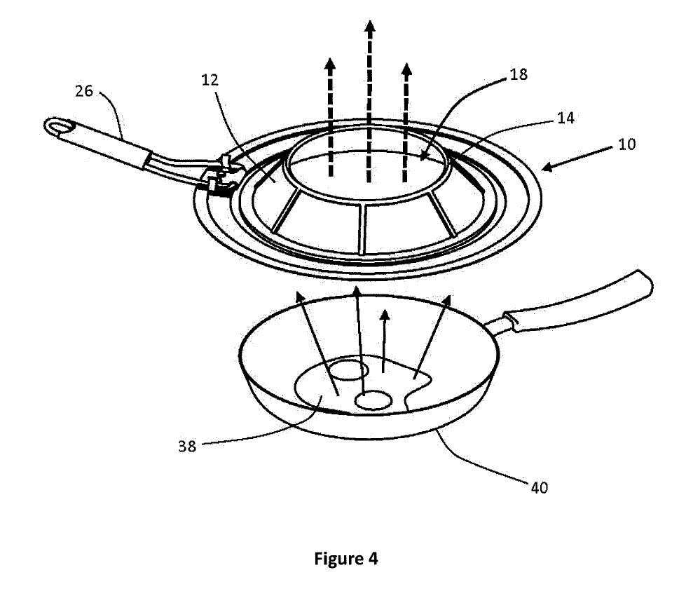

FIG. 4 provides an illustration of the embodiment of the splatter shield of FIG. 1 as it is being positioned over food 38 being cooked in a cooking vessel 40 (the heat source is note shown). In FIG. 4, the cooking food 38 is depicted as giving off splatters of grease, illustrated by the arrows of solid lines, that will largely be contained by the splatter shield 10 once it has been positioned atop the cooking vessel 40. Steam is depicted by the arrows of dashed lines as exiting from the large central opening 18 of the splatter shield 10.

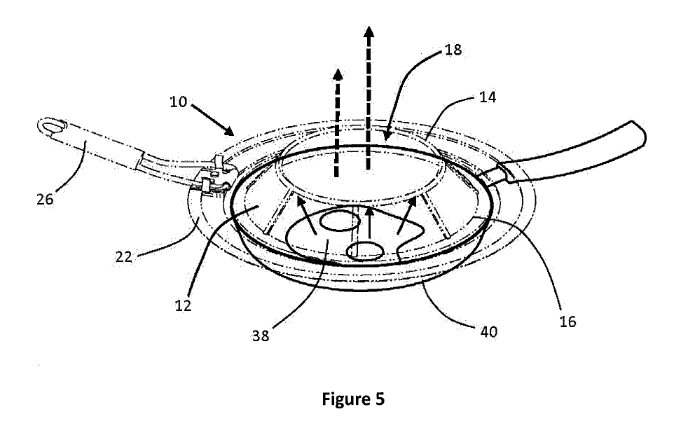

FIG. 5 provides an illustration, in dotted lines to aid in showing the use of the invention, of the splatter shield 10 resting atop a cooking vessel 40 (in this case a frying pan). Again, the heat source is not shown. The splatter shield 10 includes the circumferential sidewall 12 that slopes downwardly and radially outwardly from the upper edge or rim 14 to the bottom edge or rim 16, defining a truncated cone shape having the relatively large, central opening 18. The support rim 22 extends radially outwardly from the bottom edge 16 and supports the splatter shield 10 on the cooking vessel 40. A handle 26 is also provided.

Arrows formed by solid lines depict the ejection of grease splatters from the cooking food 38. It can be seen from FIG. 5 that only grease splatters with a substantially vertical orientation will be able to escape from the interior of the splatter shield, and those can mostly be expected to fall back into the cooking vessel 40 so as not reach the cook top or counter top (not shown). Those grease splatters that are ejected from the cooking food 38 at most angles other than vertical can be seen to impact the interior of the sloped sidewall 12, preventing the grease splatters from exiting the splatter shield 10. Further, steam is shown arrows of dashed lines as exiting from the large central opening 18 of the splatter shield 10; because of the generous size of the central opening 18, this steam will easily escape, allowing frying rather steaming of the food 38 to occur and resulting in a more palatable result.

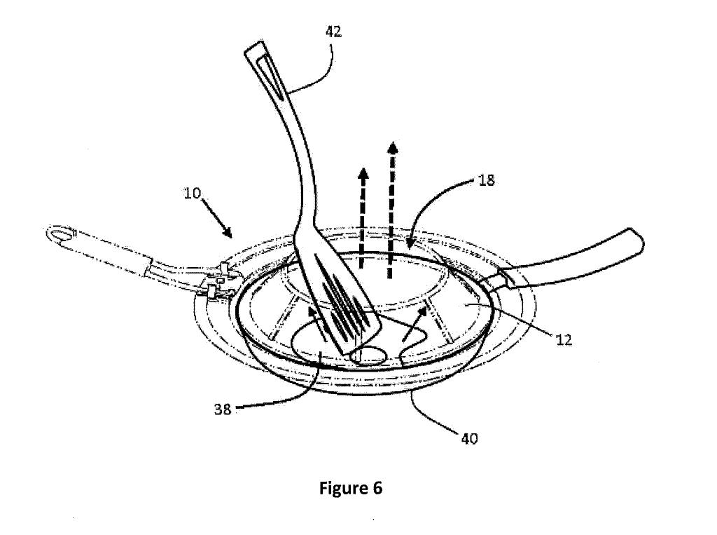

FIG. 6 provides another somewhat schematic illustration of the splatter shield 10 of the embodiment of FIG. 5 resting atop a cooking vessel 40 holding food 38 that is in the process of being cooked. In FIG. 6, a spatula 42 is shown being inserted through the large central opening 18 at the top of the splatter shield 10, manipulating the food 38 as it is being cooked. FIG. 6 illustrates that it is not necessary to remove the splatter shield 10 or uncover the cooking vessel 40 in order to stir or turn the food 38 during the cooking process. Again, grease splatters are shown by the arrows of solid lines impacting the inside of the inwardly sloping sidewall 12 and being prevented from exiting the splatter shield 10. Steam is shown again by the arrows in dashed lines freely exiting from the large central opening 18 of the splatter shield 10.

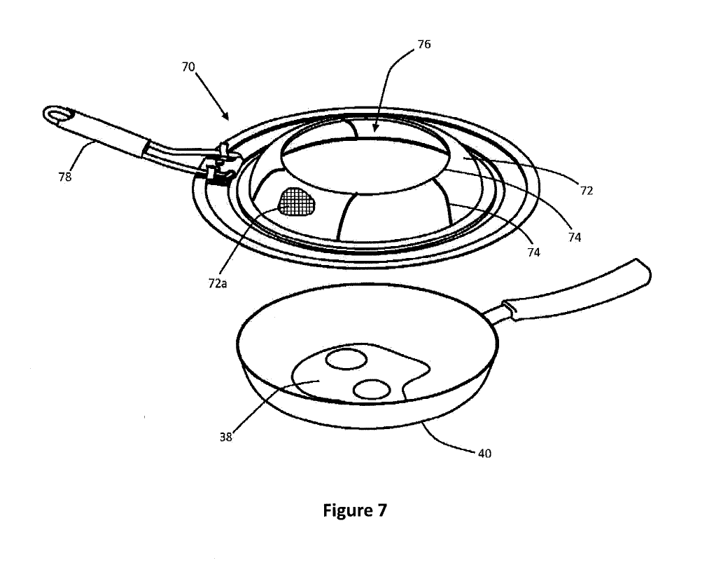

FIG. 7 provides a somewhat schematic illustration of a splatter shield 70 of a further embodiment of the invention as it is being positioned over a cooking vessel 40. In this embodiment, the splatter shield 70 includes a sidewall 72 constructed of fine metal mesh (detail shown in the insert 72a) having a mesh size small enough to prevent grease splatters from exiting through the mesh. Preferably, the sidewall 72 is formed of a stainless steel mesh construction. Stainless steel is preferred because it is non-rusting and non-reactive to food, and is able to tolerate the high heat of frying foods; it is understood that other metals such as aluminum may also be used without detracting from the intent or utility of the device. It is further preferred that the mesh of the sidewall 72 is supported by a wire framework 74.

In FIG. 7, the splatter shield 70 is shown as having a truncated dome-like configuration. The truncated dome has inwardly sloping sidewall 72 and a large upper central opening 76. A handle 78 may also be provided on the splatter shield 70. Those skilled in the art will understand that both a truncated cone and a truncated dome will function similarly and that either sidewall configuration may be used without detracting from the intent and function of the invention.

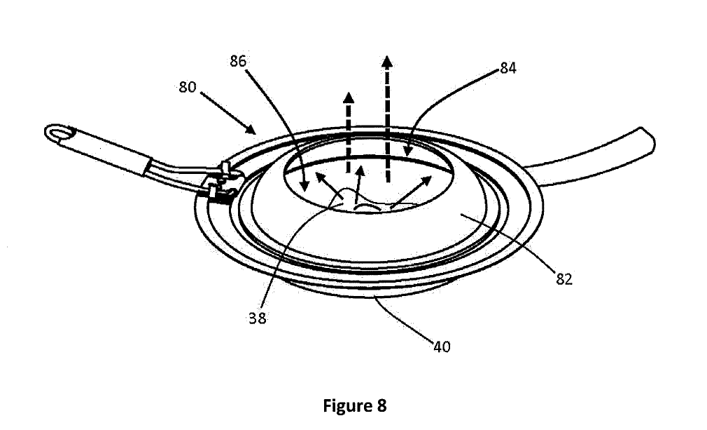

A further embodiment of the invention is shown in Figure, the splatter shield 80 being formed as a solid piece of metal or heat resistant plastic or silicone. In FIG. 8, the inwardly sloping sidewall 82 is shown as being solid; that is, without holes or openings other than the large central opening 84 at the top and the bottom opening 86 that rests over the cooking food 38. It is understood that in this embodiment, the splatter shield 80 may be fabricated as a single unitary piece, or may be comprised of several pieces mechanically held together. It is also understood that perforations (not shown) may be placed in the device sidewall to enhance steam escape. FIG. 8 shows the device with a truncated dome-like configuration; it is understood that a truncated conical configuration will function in similar fashion without detracting from the utility of function of the device. Again, splatters of grease from the cooking food 38 are illustrated by the arrows of solid lines and escaping steam is depicted by the arrows of dashed lines as exiting through the large central opening 84 of the splatter shield 80.

In accordance with the provisions of the patent statutes, the invention has been described in what is considered to represent its preferred embodiments. However, it should be noted that the invention can be practiced otherwise than as specifically illustrated and described without departing from its spirit or scope.

What is claimed is:

1. A shield for controlling grease splatter from cooking or frying foods, comprising:
an upper rim, lower rim, and a generally inwardly sloping sidewall extending contiguously between the upper and lower rim, said upper and lower rim defining an upper surface, a lower surface, and a side surface of said shield,
wherein the upper surface is generally open, said opening having a diameter measuring less than said opening of said lower surface,
wherein said upper opening being sufficiently large to permit easy entry of cooking utensils,
wherein said lower surface being generally open, said opening having a diameter measuring greater than said opening of said upper surface, and
wherein said open upper and lower surfaces forming an open passage through said shield, allowing a cooking utensil to pass unobstructed through said passage.

2. The shield of claim 1, wherein the sidewall is comprised of fine metal mesh.

3. The shield of claim 1, wherein the sidewall is comprised of fine stainless steel mesh.

4. The shield of claim 1, wherein the sidewall is comprised of heat resistant plastic.

5. The shield of claim 1, wherein the sidewall is comprised of heat resistant silicone.

6. The shield of claim 1, further comprising a handle connected to the shield.

7. The shield of claim 2, further comprising a wire framework supporting the mesh of the sidewall.

8. The shield of claim 1, further comprising a support rim extending radially outwardly from the lower rim.

9. A method of frying or cooking foods that release splattering grease droplets, comprising:
providing a splatter shield having an upper rim, a lower rim, and a generally inwardly sloping sidewall extending between the upper rim and the lower rim, defining an open lower surface and an open lower surface such that there is formed an open passage through the upper and lower surfaces,
placing said splatter shield atop a cooking vessel such that the open lower surface of the splatter shield is contiguous with and covers an open upper surface of said cooking vessel,
heating said cooking vessel,
placing food items to be cooked into said cooking vessel by inserting them through the open upper surface of said splatter shield,
allowing said food items to cook as needed within the cooking vessel,
turning, stirring, or otherwise manipulating the food items as they cook by inserting a utensil through the open upper surface of said splatter shield, and
then removing said food items from said cooking vessel through said open upper surface of said splatter shield.

10. A splatter shield for controlling grease splatter from food being cooked within a cooking vessel, comprising:
a generally annular sidewall that slopes upwardly and radially inwardly from a lower rim to an upper rim;
wherein the upper rim defines an upper opening in the splatter shield that is sufficiently large to permit the introduction of a cooking utensil therethrough, the lower rim defines a lower opening in the splash shield, and the upper opening being smaller than the lower opening.
